(19) United States
(12) Patent Application Publication
(10) Pub. No.: US 2009/0214817 A1
(43) Pub. Date: Aug. 27, 2009

(54) Panel for Furniture or the Like

(76) Inventor: Renzo Kerkoc, Bologna (IT)

Correspondence Address: Martin P. Hoffman;Hoffman, Wasson & Gitler, 2461 South Clark Street, Suite 522, Arlington, VA, 22202, US

(21) Appl. No.: 11/988,138

(22) PCT Filed: Jul. 5, 2006
(86) PCT No.: PCT/IB2006/001855

§ 371 Date: Mar. 4, 2009

(30) Foreign Application Priority Data
Jul. 5, 2005 (IT) MO2005A000169

(51) Int. Cl. A47B 96/20; B32B 3/12

(52) U.S. Cl. 428/116; 428/213

(57) ABSTRACT

The present invention refers to a panel for furniture or the like, comprising a support bearing sheet, an intermediate layer of superimposed filling material, with in between a first adhesive layer, on one surface of the bearing sheet, and a superimposed covering board, with in between a second adhesive layer, on the surface of the intermediate layer opposite the bearing sheet, the bearing sheet having a thickness greater than that of the covering board and being able to fasten anchoring means to the structure of a piece of furniture.

### TECHNICAL FIELD

The present invention refers to a panel for furniture or the like.

### BACKGROUND ART

In the furniture industry the use is known of panels made of alternative materials to solid wood, particularly for making table tops or the like, doors, structural parts, such as sides, covers and bases of wardrobes or, in general, storage units, including of large size.

Alternative materials are generally lighter compared to solid wood, with evident advantages such as, for instance, less effort required on the part of the user to open and close a door. What is more, the door support structure undergoes less stress during repeated door opening and closing operations.

The lower cost of the materials used to make the above panels also permits cutting final production costs.

A particular type of such panels is that of veneered panels, which comprise two substantially flat and parallel covering boards with, in between, a woody matrix mapped frame. An insert consisting of “poor” material, such as, for instance, polystyrene or honeycomb board is arranged between the two covering boards in the areas not occupied by the frame.

The panel is finished off by applying a perimeter edge fastened to the frame and to the edges of the two retention sheets, generally by gluing.

The two covering boards have, generally, a thickness between 1 and 3 mm and have an aesthetic panel facing function.

The two covering boards are made of woody or plastic laminate material.

The inner frame provides stability to the entire panel structure and is the panel supporting element. In particular, its mapping defines the points of application of the panel fastening means such as, for instance, hinges for doors or the like; furthermore, said frame is used to anchor the finishing edges.

Alternatively, with particular reference to the application of hinges or the like, panels are known featuring reinforcement parts in wood or the like that act as supports for the covering boards and which are able to ensure the subsequent screw fastening of the hinges.

These known panels are not without drawbacks, including the fact that the specific mapping used to make the frame, or also the use of special reinforcement parts restricts the application of the fastening means to specific areas and attachment points, thus limiting possible panel uses.

Furthermore, frame mapping calls for relatively high planning complexity with the use of equipment such as NC machines to define the seats in which to apply the fastening means and imposes operational limits such as, for instance, the establishment and management of material stocks and worked products relating to the frame and needed for panel production.

The presence of the inner frame also restricts panel shapes both during the design stage and in the case of subsequent interventions on an already worked panel. In the case in fact of wanting to subsequently shape the panel, the final shape has to be defined according to the particular shape of the inner frame.

### DISCLOSURE OF THE INVENTION

A specific aim of this invention is to eliminate the drawbacks of known technology complained of above by excogitating a panel for furniture and the like that permits the application of the fastening means at all points of the panel.

Another purpose of this invention is to simplify stock management processes.

A further purpose of this invention is to simplify panel manufacturing processes.

Another purpose of this invention is to ensure the stable gluing of the panel perimeter edge.

Furthermore, another purpose of this invention is to facilitate the shaping of the panel, including during stages subsequent to those of panel manufacturing.

Another purpose of this invention is to permit the use of materials generally employed in the production of panels for furniture or the like.

As part of such technical aim, another purpose of the present invention is to achieve the previous aims with a simple structure, of relatively practical implementation, safe use and effective operation, as well as of a relatively low cost.

This aim and these purposes are all achieved by the present panel for furniture or the like, characterized by the fact that it comprises a support bearing sheet, an intermediate layer of superimposed filling material, with in between a first adhesive layer, on one surface of the support bearing sheet, and a superimposed covering board, with in between a second adhesive layer, on the surface of the intermediate layer opposite the bearing sheet, the bearing sheet having a thickness greater than that of the covering board and being able to fasten anchoring means to the structure of a piece of furniture.

### BRIEF DESCRIPTION OF THE DRAWINGS

Further characteristics and advantages of this invention will appear even more evident from the detailed description of a preferred, but not exclusive, form of embodiment of a panel for furniture and the like, illustrated by way of non limiting example in the accompanying drawings, wherein:

FIG. 1 is an axonometric view of a panel's detail, according to the invention;

FIG. 2 is a side view of a panel's detail, according to the invention;

FIG. 3 is a view of a panel's detail, according to the invention with perimeter edge.

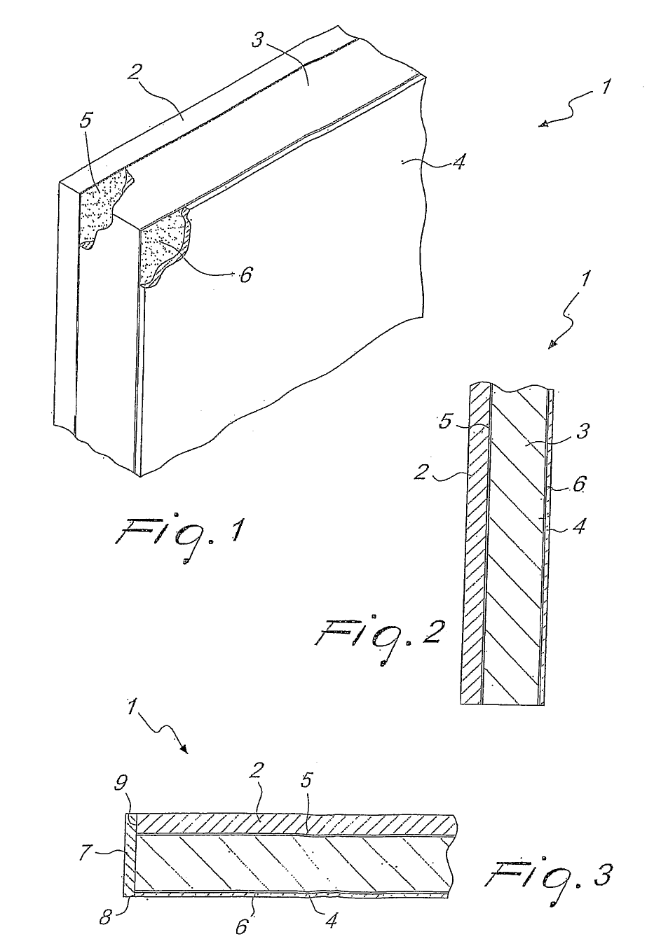

### WAYS OF CARRYING OUT THE INVENTION

With special reference to such figures, a panel for furniture or the like has been generally designated by reference numeral 1.

In the particular form of embodiment shown in the figures, panel 1 has a substantially flat conformation, but alternative forms of embodiment are not to be ruled out in which the panel features curves, in particular, for instance, to make curved furnishing components.

The panel 1 comprises a support bearing sheet 2 on which is superimposed, on one of its surfaces, an intermediate layer 3.

A covering board 4 is superimposed on the surface of the intermediate layer 3 opposite the surface fastened to the bearing sheet 2. The covering board 4 is arranged substantially parallel to the same bearing sheet 2 and defines the visible surface of the panel 1.

In particular, the intermediate layer 3 is fastened to the bearing sheet 2 by means of the interposition of a first adhesive layer 5 and the covering board 4 is fastened to the intermediate layer 3 by means of the interposition of a second adhesive layer 6.

The bearing sheet 2 is suitable for fastening anchoring means to the structure of a furniture unit or the like, such as hinges, brackets, supports, feet and other hardware.

The thickness of the bearing sheet 2 is greater than the thickness of the covering board 4.

In particular, the thickness of the bearing sheet 2 is between 4 and 14 mm, the thickness of the covering board 4 is between 0.3 and 4 mm, while the thickness of the intermediate layer 3 is between 3 and 60 mm.

In the specific form of embodiment represented in the above figures, the thickness of the bearing sheet 2 is 7 mm, while the thickness of the covering board 4 is 1 mm.

Advantageously, the bearing sheet 2 and the covering board 4 are made of wood material of the type comprising wood fibres compacted and assembled by interposition of a binder or organic and/or synthetic materials.

Alternatively, the bearing sheet 2 and the covering board 4 are made of plastic or metal material.

Advantageously, the intermediate layer 3 is made of material such as polymer foams or, alternatively, honeycomb structures, so as to allow achieving a lightweight panel structure. The use cannot however be ruled out of different types of materials.

As shown in FIG. 3, the finish of panel 1 is done by applying an edge 7 on at least one portion of the perimeter of such panel 1.

In particular, the edge 7 is fastened by gluing to the surround of the bearing sheet 2 and of the covering board 4, respectively, on the contact surfaces marked 8 and 9 in FIG. 3.

It has in fact been ascertained how the described invention achieves the set purposes and in particular, the fact is underlined that the use of the bearing sheet permits the application of the fastening means at all points of the panel.

Furthermore, the number of elements making up the panel is limited, thus permitting simplification of stock management and production processes.

To this must be added the fact that the thickness of the bearing sheet ensures stable fastening of the panel finish perimeter edge, restricting the retention area of the edge itself and without the need to use an inner frame; this does in any case allow the product to correctly perform the required function.

The invention thus conceived is susceptible of numerous modifications and variations, all of which falling within the scope of the inventive concept.

Furthermore all the details can be replaced with others that are technically equivalent.

In practice, the materials used, as well as the shapes and dimensions, may be any according to requirements without because of this moving outside the protection scope of the following claims.

1. Panel for furniture or the like, comprising a support bearing sheet, an intermediate layer of superimposed filling material, with in between a first adhesive layer, on one surface of said bearing sheet, and a superimposed covering board, with in between a second adhesive layer, on the surface of said intermediate layer opposite said bearing sheet, said bearing sheet having a thickness greater than that of said covering board and being able to fasten anchoring means to the structure of a piece of furniture.

2. Panel according to claim 1, wherein the thickness of said bearing sheet is between 4 and 14 mm.

3. Panel according to claim 1, wherein the thickness of said covering board is between 0.3 and 4 mm.

4. Panel according to claim 1, wherein the thickness of said intermediate layer is between 3 and 60 mm.

5. Panel according to claim 1, wherein said bearing sheet is made of wood.

6. Panel according to claim 1, wherein said wood comprises agglomerate wood fibers.

7. Panel according to claim 1, wherein said bearing sheet is made of plastic.

8. Panel according to claim 1, wherein said bearing sheet is made of metal.

9. Panel according to claim 1, wherein said intermediate layer is made of polymer foam.

10. Panel according to claim 1, wherein said intermediate layer is made of honeycomb structures.

11. Panel according to claim 1, wherein said covering board is made of wood.

12. Panel according to claim 1, wherein said covering board is made of plastic.

13. Panel according to claim 1, wherein said covering board is made of metal.

14. Panel according to claim 1, comprising at least one edge applied on at least one portion of the perimeter.

15. Panel according to claim 1, which has a substantially flat conformation.

16. Panel according to claim 1, which has a substantially curved conformation.
